(19) United States
(12) Patent Application Publication
(10) Pub. No.: US 2015/0142515 A1
(43) Pub. Date: May 21, 2015

(54) METHODS, SYSTEMS AND COMPUTER READABLE MEDIA FOR DETERMINING A RELATIONAL STRENGTH INDEX ASSOCIATED WITH A PLURALITY OF MERCHANT ENTITIES

(71) Applicant: MasterCard International Incorporated, Purchase, NY (US)

(72) Inventors: Debashis Ghosh, Charlotte, NC (US); Randy Shuken, Westport, CT (US)

(73) Assignee: MasterCard International Incorporated, Purchase, NY (US)

(21) Appl. No.: 14/085,777

(22) Filed: Nov. 20, 2013

(51) Int. Cl. G06Q 30/02

(52) U.S. Cl. CPC G06Q 30/0202
USPC 705/7.31

(57) ABSTRACT

Methods, systems, and computer readable media for determining a relational strength index between merchant entities are disclosed. In one example, the method includes applying at least one data filter to stored customer transaction data to produce relevant customer transaction data associated with a first merchant entity. The method also includes processing the relevant customer transaction data to determine a set of customers that conducted purchase transactions at both the first merchant entity and a second merchant entity and utilizing the set of customers to determine a relational strength index that represents a strength of a transactional affinity between the first merchant entity and the second merchant entity.

### TECHNICAL FIELD

The subject matter described herein relates to the use of customer transactions to determine a relationship between merchant entities. More particularly, the subject matter described herein relates to systems, methods, and computer readable media for determining a relational strength index associated with a plurality of merchant entities.

### BACKGROUND

Presently, merchant entities (e.g., retail stores or retail websites) are fully capable of determining the type of purchases conducted by their own respective customers. Utilizing this purchase information, a merchant entity is able to determine the buying tendencies of their customers. This information may therefore be used to improve a merchant's marketing and advertising efforts as well as to optimize the merchant's promotions or coupon offerings. However, the value of the merchant's transaction data is limited since the information is only related to the merchant's own offered merchandise. Namely, although a merchant entity is able to determine a customer's buying tendencies as it relates to products and services provided by the merchant's own store(s), that same merchant entity is incapable of knowing what other merchant stores its customers visit. Thus, the merchant is unaware if a customer traffic relationship exists between the merchant and any other merchant entity. If such a nexus between merchant entities was known, the business practices of the merchant entities could be further improved and optimized.

Accordingly, there exists a need for improved systems, methods, and computer readable media for determining a relational strength index associated with a plurality of merchant entities.

### SUMMARY

According to one aspect, the subject matter described herein relates to, methods, systems, and computer readable media for determining a relational strength index associated with a plurality of merchant entities. In one embodiment, the method includes applying at least one data filter to stored customer transaction data to produce relevant customer transaction data associated with a first merchant entity. The method also includes processing the relevant customer transaction data to determine a set of customers that conducted purchase transactions at both the first merchant entity and a second merchant entity and utilizing the set of customers to determine a relational strength index that represents a strength of a transactional affinity between the first merchant entity and the second merchant entity.

The subject matter described herein may be implemented in hardware, software, firmware, or any combination thereof. As such, the terms “function”, “node”, “unit”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for determining a relational strength index associated with a plurality of merchant entities according to an embodiment of the subject matter described herein;

FIGS. 2A and 2B are flow charts illustrating exemplary methods for using data filters to determine a relational strength index according to an embodiment of the subject matter described herein;

FIG. 3 is a flow chart illustrating an exemplary process for determining a relational strength index associated with a plurality of merchant entities according to an embodiment of the subject matter described herein;

FIG. 4 is a block diagram illustrating a relationship between a plurality of customers and a plurality of merchant entities according to an embodiment of the subject matter described herein; and

FIG. 5 is a block diagram illustrating the relational strength index associated with a plurality of merchant entities according to an embodiment of the subject matter described herein.

### DETAILED DESCRIPTION

In accordance with the subject matter disclosed herein, methods, systems, and computer readable media for determining a relational strength index associated with a plurality of merchant entities are disclosed. In some embodiments, the present subject matter involves the application of data filters to stored customer transaction data in order to obtain pertinent and relevant customer transaction data associated with a first merchant entity. The relevant customer transaction data may then be processed to determine a set of customers that conducted purchase transactions at both the first merchant entity and at least a second merchant entity. As used herein, the term “set” may refer to a sum, a count, a number, a grouping, etc. of customers. The determined set of customers may subsequently be used to derive a relational strength index that represents the strength of a transactional affinity (e.g., a relationship) between the first merchant entity and the second merchant entity. For example, a transactional affinity may describe the likelihood that customers visiting a first particular merchant store/location will visit a second particular merchant store/location. The aforementioned process may also be conducted multiple times with different merchant entities in order to determine multiple relational strength indices. Notably, the relational strength index may be represented in a numerical or graphical manner.

The present subject matter may prove to be beneficial in several business related fields and areas. For example, the relational strength index derived by the present subject matter may be utilized for optimizing marketing and advertising efforts, for effectively promoting loyalty programs associated with a merchant entity (e.g., conduct a tie in promotion with other merchant entities identified as sharing a particular affinity level), for strategically planning new store locations, or for improving any other business related task. For example, one exemplary use case may include a joint marketing promotion where a high relational strength index between two merchant entities exists. Identifying such joint marketing promotion possibilities can be profitable to merchant entities since successful joint marketing promotions have the effect of reducing costs for both merchants (e.g., by sharing costs) and generating more customer traffic resulting in increased sales. The present subject matter may also be utilized advantageously by retail analysts, banks, and hedge funds managers.

It is important to note that the present subject matter is not disclosing a customer's real identity or purchase information related to a particular sale, but rather disclosing a relational strength index that represents the likelihood that a customer conducting a purchase transaction at a first merchant entity is likely (e.g., a high affinity) or unlikely (e.g., a low affinity) to make a subsequent purchase at one or more other identified merchant entities.

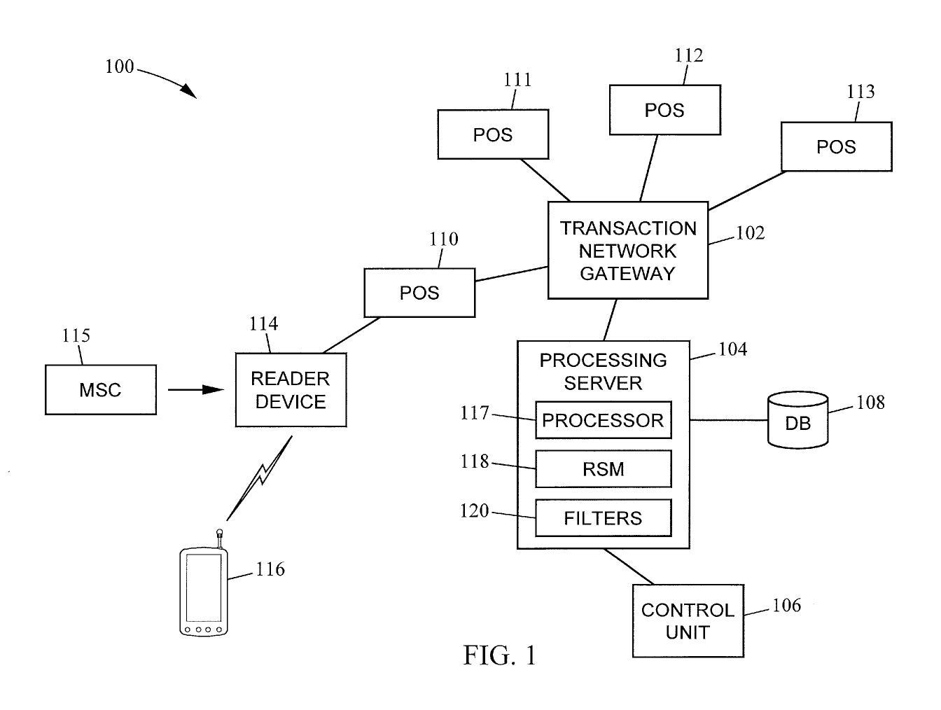

FIG. 1 depicts an exemplary purchase transaction system 100 that includes a plurality of point of sale (POS) devices 110-113, a transaction network gateway 102, a processing server 104, a data storage unit 108, and a control unit device 106. FIG. 1 further depicts a magnetic stripe card 115 and a mobile device 116 that may be utilized by a customer at a reader device 114.

In some embodiments, each of POS devices 110-113 may include any type of device or unit that is configured to facilitate a credit card transaction. Exemplary POS devices include self-service kiosks, self-checkout units, point of sale cashier terminals, and the like. In some embodiments, each of POS devices 110-113 depicted in FIG. 1 may be associated with a separate merchant entity and/or positioned at a unique merchant location. A POS device may also be configured to communicate with a nearby reader device, e.g., reader device 114. Exemplary reader devices may include a magnetic stripe reader, a wireless smartcard reader, a wireless device reader, and the like. For example, reader device 114 in FIG. 1 may include a magnetic stripe reader that is configured to read a swiped magnetic stripe card 115. Reader device 114 may also include a wireless device reader that is configured to wirelessly communicate with a near field communications (NFC) enabled smartcard or mobile device 116 in order to wirelessly receive credit card information (e.g., credit card credentials) to facilitate a purchase transaction at POS device 110 (e.g., wirelessly receiving credit card data associated with a soft card application via NFC). Although FIG. 1 only depicts a single reader device 114, each of POS devices 111-113 may be communicatively connected to its own reader device.

Upon receiving credit card information from reader device 114, POS device 110 may utilize the received information to conduct a purchase transaction. Notably, customer transaction data may be generated from such a purchase transaction and may subsequently be sent from POS device 110 to transaction network gateway 102. Similarly, transaction network gateway 102 may be configured to receive other customer transaction information from other merchant entities via a plurality of POS devices (e.g., POS devices 111-113). In some embodiments, transaction network gateway 102 may include any gateway server, node, or unit that serves as an entry and exit point for communications (e.g., packet traffic) entering and leaving a payment transaction network and associated infrastructure (e.g., MasterCard network infrastructure or “MasterCard payment network”). Gateway 102 may be communicatively connected to processing server 104, which is also located in the payment transaction network.

In some embodiments, processing server 104 may include any server, node, or unit that is configured to process customer transaction data to determine a relational strength index using the methods described herein. Although FIG. 1 depicts processing sever 104 as a single network element, processing server 104 may include a plurality of network elements, a plurality of network components, and/or a network itself (e.g., a MasterCard transaction network) without departing from the scope of the present subject matter. Processing server 104 may include a processor 117, a relational strength module (RSM) 118, and a plurality of data filters 120. In some embodiments, processor 117 may include a microprocessor, central processing unit (CPU), or any other like hardware based processor unit that is configured to execute and/or utilize RSM 118 (e.g., a software based algorithm) and data filters 120 to derive a relational strength index. Each of RSM 118 and data filters 120 may be stored in memory (not shown), such as random access memory (RAM), read only memory (ROM), optical read/write memory, cache memory, magnetic read/write memory, flash memory, and the like. In one embodiment, processor 117 and memory may be used to execute and manage the operation of RSM 118.

In some embodiments, data filters 120 may include a plurality of data filters stored in a database or memory located in processing server 104. Data filters 120 may include different types of filters that may be applied to customer transaction data stored in data storage 108. Exemplary data filters may include time based filters configured to extract data based on a location-based parameter, such as a particular hour of the day, a day of the week, or any defined time period (e.g., last 30 minutes, 24 hours, 14 days, 5 years, etc.). Other data filters may also include geographical based filters configure to extract data based on location-based parameters, such as defined area. Exemplary defined areas include a defined city, county, region, or state. The defined area may also include a defined square mile area or a defined distance from a designated merchant entity location. Additional data filters may also include monetary based parameters, such as defined monetary thresholds or defined monetary ranges.

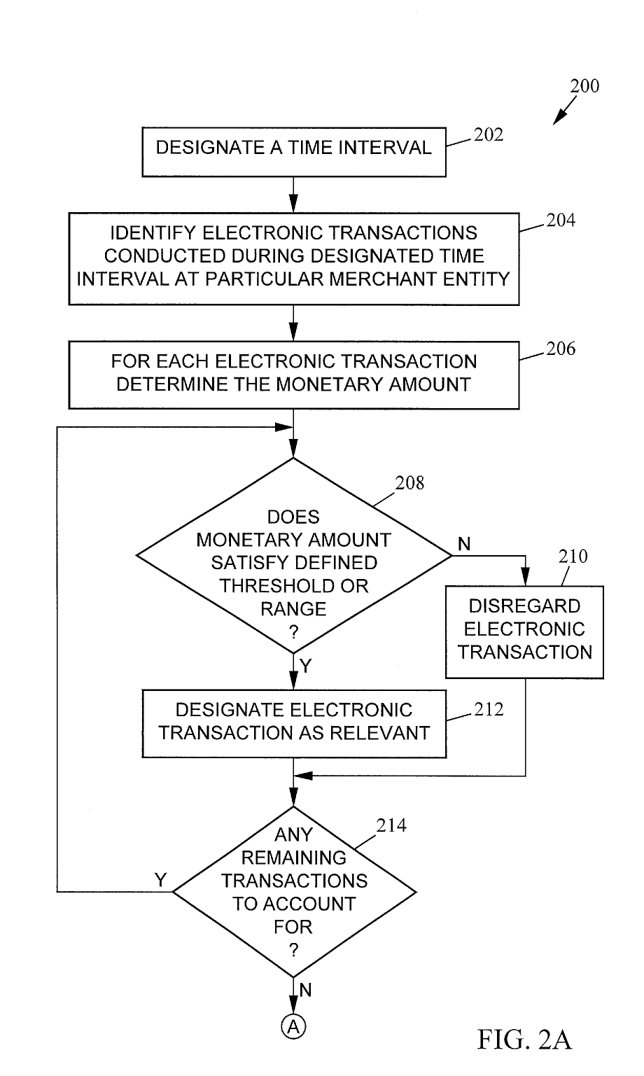

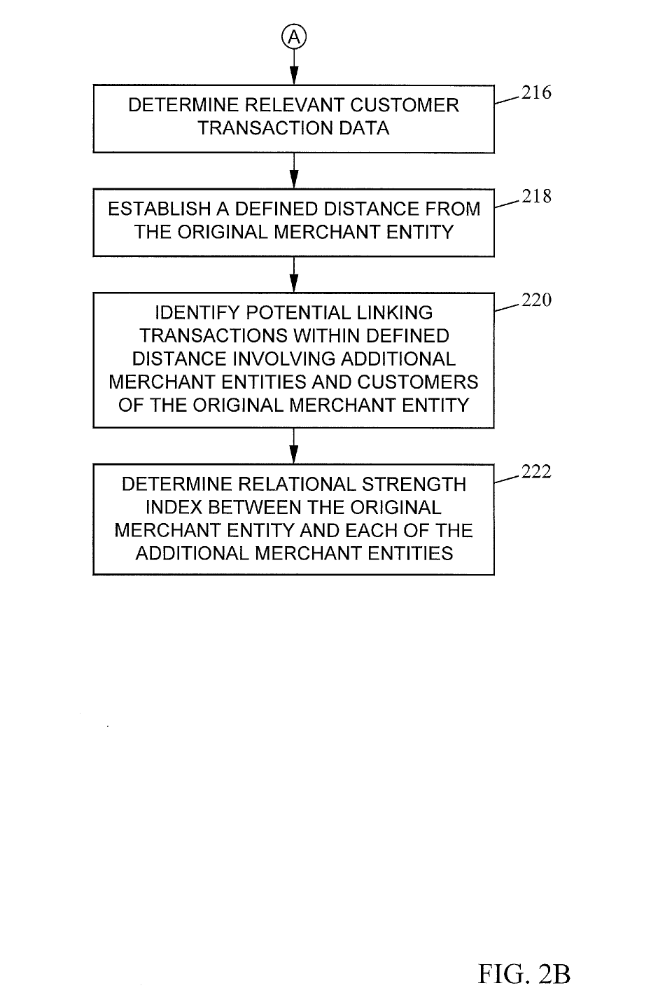

One example of utilizing data filters to determine relational strength indices is illustrated as a method 200 depicted in FIGS. 2A and 2B. In step 202, a time interval is designated. In one embodiment, a relevant time interval may be established by a processing server or a system administrator. The designation of the time interval may be based on any number of different factors. For example, the designated time interval may be selected in a manner that helps ensure that merchant entity relationships or links are based on pertinent criteria, such as geography, population, traffic patterns, and/or other relevant factors. For instance, in geographical areas that are characterized by a high density of merchants (e.g., a well-established commercial zone, such as a mall or a shopping center), the designated time interval filter may be defined as a relatively short duration to help ensure that customer transactions used to determine the relational strength between merchants (as described in more detail below) are associated. Similarly, in geographical areas that are characterized by a sparse number of merchant entities (e.g., in a rural setting), the designated time filter may include a longer time interval to account for customers that may need to travel substantial distances (or for long time durations) between two or more merchant entities.

In step 204, electronic transactions conducted at a particular merchant entity during designated time interval are identified. As used herein, an “electronic transaction” may include either an electronic payment transaction (e.g., a credit card purchase transaction, a debit card purchase transaction, a prepaid card purchase transaction, etc.) or an electronic non-payment transaction (e.g., a loyalty transaction, coupon redemption transaction, a ticket redemption transaction, etc.). Although the following example describes the electronic transaction as a payment transaction, non-payment transactions may also be conducted without departing from the scope of the present subject matter. In one embodiment, all of the customer transactions that are conducted at a particular merchant entity during the designated time interval are determined. For example, the present subject matter may account for all of the payment transactions occurring at a particular Target store in the past 24 hours.

In step 206, a monetary amount for each electronic transaction is determined. For example, the monetary amount for each of the customer payment transactions occurring at the Target store in the past 24 hours is ascertained and recorded.

In step 208, a determination as to whether or not the amount of a given electronic transaction satisfies a defined monetary threshold or range is made. In some embodiments, data filters pertaining to monetary value thresholds or monetary value ranges may be utilized. For example, the processing server may be configured to identify and account for electronic transactions associated with a certain monetary value (e.g., a purchase transaction that exceeds a designated monetary value threshold or falls between a defined range of acceptable monetary values) in addition to being conducted at a particular merchant during a designated time interval. Notably, the selection of electronic transactions corresponding to a certain monetary value may help ensure that the set of transactions to be considered is not skewed (e.g., by disregarding insignificant and/or minor transactions). Similarly, the selection of transactions associated with a certain monetary value can help ensure that only relevant transactions are considered for further analysis. For example, if a particular merchant entity is a fuel station, a monetary threshold may be selected to help ensure that irrelevant non-fuel transactions are excluded (or included) from analysis (e.g., a 25 cent chewing gum purchase the fuel station). If the monetary amount of the electronic transaction does not satisfy the defined monetary threshold or range, then method 200 proceeds to step 210 where the electronic transaction is disregarded. If the monetary amount of the electronic transaction satisfies the defined monetary threshold or range, then method 200 proceeds to step 212 where the electronic transaction is designated as being relevant.

At step 214, a determination is made as to whether or not any remaining electronic transactions are to be accounted for (i.e., determine whether the transaction includes an acceptable monetary value). If all of the identified electronic transactions have been accounted, then method 200 proceeds to step 216. Otherwise, method 200 loops back to step 208 to designate or disregard additional electronic transactions.

In step 216, relevant customer transaction data is determined. In one embodiment, the processing server may identify all of the relevant customer transactions. For example, the processing server may be configured to identify each of the electronic customer transactions conducted at the Target store in the last 24 hours that meet a defined monetary threshold of 5 dollars.

In step 218, a defined distance from the original merchant entity is established. In one embodiment, a particular distance from or area surrounding the original merchant entity is established. For example, the processing server may be configured to consider define an area that includes a 10 mile radius surrounding the Target store.

In step 220, potential linking transactions within the defined distance involving additional merchant entities and customers of the original merchant entity are identified. In one embodiment, the set of potential linking transactions includes all electronic transactions conducted by the set of customers at other merchant stores/entities (which are located within the defined distance from the original merchant entity) during the designated time interval.

In step 222, a relational strength index between the original merchant entity and each of the additional merchant entities is determined. After a set of potential linking transactions is identified, a set of customers that conducted purchase transactions at the first merchant entity and the additional merchant entities (e.g., via the potential linking transactions) is determined. In one embodiment, the set of customers includes one or more common customers that made purchase transactions at both the merchant entity and one or more of the additional merchant entities (i.e., where the set of potential linking transactions occurred). In some embodiments, the identified purchase transactions collectively conducted by the set of customers are used to determine the strength of a given merchant relationship, which may be represented by a relational strength index. For example, the relational strength index may be a value that is determined from the number of transactions conducted by common customers at two merchant entities within the designated time interval.

In some embodiments, a relational strength index between merchants can be computed based on a simple count. For example, suppose 100 customers conducted a credit card purchase transaction at both a Walgreens pharmacy and a Wendy's restaurant in a particular county (or other defined area) during a defined 24 hour period. Similarly, suppose 67 customers conducted a credit card purchase transaction at both a CVS pharmacy and a McDonald's restaurant in the same defined area and same defined time period. In this particular example, the relational strength index associated with both Walgreens and Wendy's is determined to be “100” and the relational strength index associated with both CVS and McDonald's is determined to be “67”. Furthermore, a relational strength index computation can be further processed (e.g., subjected to further granularity) to consider additional parameters, such as micro-territories within the defined area and specific hours during the predefined time period/interval.

Returning to FIG. 1, in some embodiments, data storage unit 108 may include any storage medium that is configured to store customer transaction data. Exemplary data storage units may include one or more dedicated database servers accessible by processing server 104 or may include a local database located within processing server 104. In some embodiments, data storage unit 108 may be provisioned with customer transaction data provided by processing server 104. In some embodiments, the customer transaction data stored in data storage unit 108 is both anonymous (e.g., customer real identity is omitted) and aggregated.

In some embodiments, control unit 106 may include a computer console or device that may be utilized by a network operator to select the data filters to be used in the determination of the relational strength index. Control unit 106 may also be utilized to generate a data filter for use by processing server 104. Similarly, a network operator may use control unit 106 to send a request message to processing server 104 to request the calculation of the relational strength index based on one or more data filters.

In some embodiments, processor 117 executes and runs RMS 118 to determine a relational strength index associated with a merchant entity. For example, if a relational strength index for a first merchant entity in light of customer traffic/transactions occurring in the last 60 days, RSM 118 utilizes data filters related to the first merchant entity (e.g., a first merchant entity identifier filter) and a 60 day duration data filter to customer transaction data stored in data storage unit 108. Upon applying the data filters to the customer transaction data, RSM 118 may be able to obtain a subset of the aggregated customer transaction data. This pertinent subset of customer transaction data that is obtained after the application of appropriate data filters may be designated as “relevant customer transaction data”. RSM 118 may then be used to process the relevant customer transaction data to determine a set of customers that have conducted purchase transactions at the first merchant entity and some other merchant entity (e.g., determine a set of common customers that conducted a purchase transaction at both the first merchant entity and a second merchant entity, at both the first merchant entity and a third merchant entity, at both the first merchant entity and a fourth merchant entity, etc.). As indicated above, the term “set” may refer to a sum, a count, a number, a grouping, etc. of customers.

In some embodiments, the set of customers may include all customers that transacted at the particular merchant store location during a designated time interval. In another embodiment, the set of customers may include customers that completed transactions associated with a certain monetary value during a designated time interval. In one embodiment, the certain monetary value is selected based upon transactions that exceed a designated monetary value threshold. In another embodiment, the certain monetary value is selected based upon transactions that do not exceed a certain monetary value threshold. In one embodiment, the monetary value threshold is based on a pre-calculated average transaction purchase amount at the particular merchant. In yet another embodiment, the certain monetary value is selected based upon electronic transactions that fall within a designated range of monetary values. In such embodiments, the selection of a monetary threshold or range can help ensure that certain irrelevant electronic transactions conducted at a particular merchant do not skew the transactional data to be analyzed or filtered.

After determining the set of customers, RSM 118 may be used to determine a relational strength index that represents the strength of the relationship (i.e., a transactional affinity) between the first merchant entity and each of the other merchant entities. In some embodiments, the relational strength index may be determined using i) the frequency in which common customers shopped at the two associated merchant entities, ii) the geographical distance in which common customers needed to travel between the two associated merchant entities, iii) the elapsed time period in which the common customers shopped at the two associated merchant entities, and the like. In some embodiments, RSM 118 may be configured to represent the determined relational strength index in a numerical manner (e.g., statistical distribution, an ordered list, etc.) or in a graphical manner (e.g., manipulating the color, thickness, or number of connecting lines on a visual display).

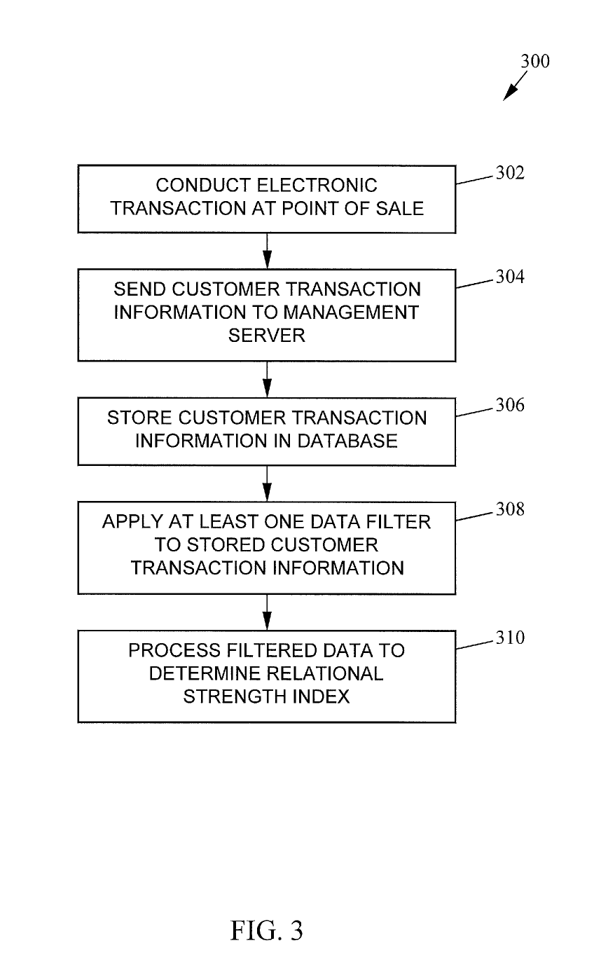

FIG. 3 is a flow chart illustrating an exemplary method 300 for determining a relational strength index between merchant entities according to an embodiment of the subject matter described herein. In some instances below, system components described in FIG. 1 will be referenced for the purpose of providing an example how processing server 104 determines a relational strength index.

In step 302, an electronic transaction is conducted at a POS device or terminal. As mentioned above, an “electronic transaction” may include either an electronic payment transaction (e.g., a credit card purchase transaction, a debit card purchase transaction, a prepaid card purchase transaction, etc.) or an electronic non-payment transaction (e.g., a loyalty transaction, coupon redemption transaction, a ticket redemption transaction, etc.). In some embodiments, a customer may initiate a purchase transaction at reader device 114 and POS device 110 (e.g., checking out at a cashier or self-checkout) at a merchant location, such as a merchant store.

In one embodiment, an electronic transaction may be initiated by a consumer at point of sale device 110. Upon presenting and/or interfacing the credit card (e.g., magnetic strip card 115 or an electronic credit card provisioned on mobile device 116) with reader device 114, POS device 110 may obtain credit card credentials and related data from the credit card and subsequently generate customer transaction data. Exemplary customer transaction data includes a personal account number (PAN), the customer's state of residence, a time stamp of the purchase transaction (e.g., date and time information), the dollar amount spent, a merchant identifier, a merchant location identifier, and the like. In some embodiments, the electronic transaction may be initiated by a customer presenting and/or interfacing a loyalty card with a reader device (e.g., reader device 114). In such scenarios, the reader device or a POS device may obtain the customer's loyalty information to generate customer transaction data.

In step 304, customer transaction information is sent to a processing server. In some embodiments, POS device 110 generates customer transaction information based on the current purchase transaction. The customer transaction data associated with the customer's payment transaction may subsequently be sent by POS device 110 to processing server 104 via a transaction network gateway server 102, such as a MasterCard payment network gateway server. In some embodiments, a reader device or a POS device may generate the customer transaction information based on the obtained loyalty card information based on the current loyalty transaction information. In such instances, the loyalty transaction information is sent by the reader device or the POS device to a loyalty processing server (e.g., processing server 104). In some embodiments, the loyalty processing server may be managed by a third party entity or company that is responsible for managing loyalty programs associated with a plurality of merchant entities.

In step 306, the customer transaction information is stored. In some embodiments, processing server 104 may be configured to store the received customer transaction information in local storage, such as a database. In other embodiments, the customer transaction data may be stored in an external database, such as or data storage unit 108, which is accessible to processing server 104. In some embodiments, the storing of the customer transaction data includes the aggregating of the received customer transaction data with the existing transaction information previously stored in the database.

In step 308, at least one data filter is applied to the stored customer transaction information. In some embodiments, a relational strength module 118 executed by processing server 104 may be configured to apply one or more data filters to the stored customer transaction data. As indicated above, the at least one filter may include a time based filter, a geography based filter, or some other filter.

In one embodiment, a request may be received at processing server 104 for a relational strength index associated with a merchant entity. For example, processing server 104 may receive a request from a control unit 106 or an operator for at least one relational strength index that is associated with a particular merchant entity. In some embodiments, the merchant entity indicated in the request may generally include all the store locations a particular company or corporation currently operates (e.g., ACME corporation). Alternatively, a merchant entity specified may be described in the request as a particular merchant store at a particular location (e.g., the ACME store located on Main Street in Springfield, Ill.).

In step 310, the filtered customer transaction data is processed to determine a relational strength index. In some embodiments, relational strength module 118 may be executed by processing server 104 and may be configured to process the filtered (i.e., relevant) customer transaction data to determine a relational strength index between the merchant entity and some other merchant entity. In some embodiments, relational strength module 118 may be configured to determine a set of common customers that conducted purchase transactions at both the first merchant entity and a second merchant entity. Upon determining this set of customers (within the constraints of the previously applied data filters), relational strength module 118 may be configured to calculate a relational strength index that represents the strength of the relationship (i.e., a transactional affinity) between the first merchant entity and the second merchant entity. The relational strength index may be represented either numerically or graphically by relational strength module 118.

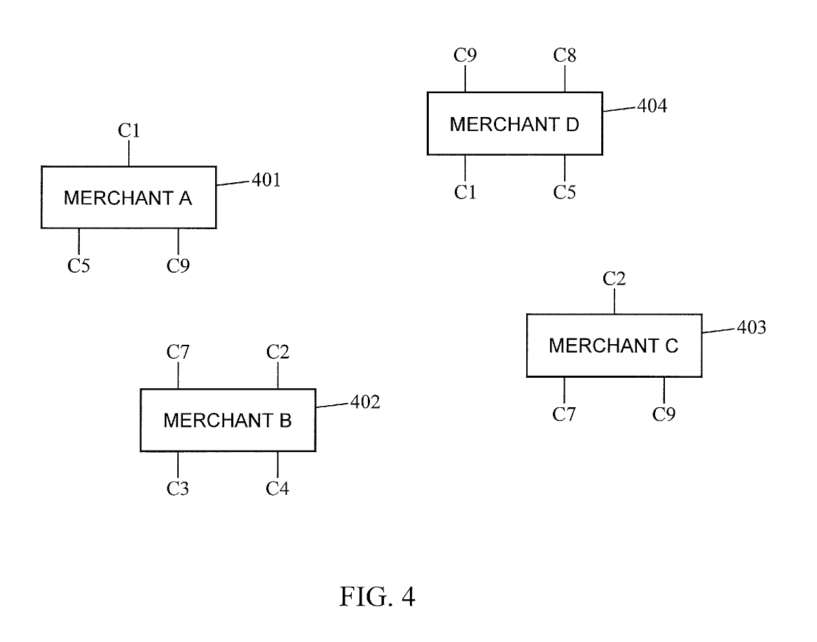

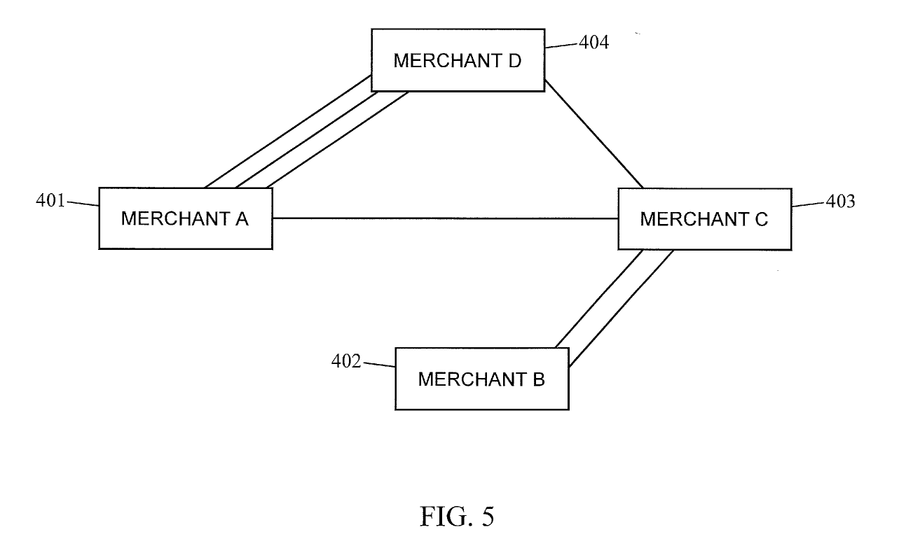

FIG. 4 illustrates a graphical representation between customers and merchant entities. Namely, FIG. 4 depicts a plurality of merchant entities 401-404, where each of merchant entities 401-404 is be associated with a different plurality of customers. Each “C numeral” depicted in FIG. 4 may represent a customer that conducts a purchase transaction at a POS location associated with merchant entities 401-404. For example, FIG. 4 depicts merchant A 401 being associated with three customers, which are represented as C1, C5, and C9, that conducted purchase transactions at a particular store location associated with merchant A 401. FIG. 4 further depicts merchant B 404 as being associated with customers C2, C3, C4, and C7 and merchant C as being associated with customers C2, C7, and C9. Similarly, FIG. 4 depicts merchant D 404 as being associated with customers C2, C7 and C9. The information graphically represented in FIG. 4 provides the basis for the graphical representation displayed in FIG. 5. In some embodiments, RSM 118 may be configured to generate the graphical representation of FIG. 4 on a visual display.

FIG. 5 illustrates an exemplary graphical representation of the relational strength index. As shown in FIG. 4, merchant entities 401-404 facilitate a purchase transaction with a plurality of customers 01-09. However, FIG. 5 graphically illustrates a number of relational strength indices existing among merchant entities 401-404 as shown on a visual display. As used herein, a visual display may include a screen display (e.g., a screen associated with a computer, tablet, television, or any other like electronic device), a tangible print out (e.g., paper print out, a poster, etc.), or any other means which can graphically represent the relational strength index to a viewer. In some embodiments, the present subject matter may be displayed in a manner that involves overlaying the representation of the relational strength index over a map. For example, the lines may be depicted as connecting different merchant entities, wherein the merchant entity locations are accurately indicated at their proper position on the overlaid map. In some embodiments, RSM 118 may be configured to generate the graphical representation of FIG. 5 on a visual display.

Returning to FIG. 5, the number of lines connecting two merchant entities serves as a graphical representation of the relational strength index (e.g., the strength of the transactional affinity between two merchant entities) of the two connected merchant entities. For example, the three common customers serviced by both merchant entity A 401 and merchant entity D 404 are depicted as three separate lines and may indicate a strong transactional affinity between the two merchant entities. Consequently, the complete lack of lines between merchant entity A 401 and merchant entity B 402 graphically indicate a weak or non-existent relational strength index. Notably, the graphical representation of the relational strength index as depicted in FIG. 5 may be easily converted into a numeric value that represents the relational strength index.

In an alternate embodiment, instead of depicting the number of lines connecting two merchant entities on a screen display as shown in FIG. 5, the relational strength index may be graphically represented by the width of a single line connecting two merchant entities. For example, the magnitude of the relational strength index between two merchant entities may be directly proportional to the thickness of the displayed connecting line (e.g., the thicker the line, the stronger the transactional affinity/relationship between the two merchant entities). In yet another embodiment, the relational strength index between two merchant entities may be represented by different colored lines (e.g., “warmer colors” like red and orange indicate a strong relational strength index shared between the two merchant entities) on a display.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for determining a relational strength index between merchant entities, the method comprising:
applying at least one data filter to stored customer transaction data to produce relevant customer transaction data associated with a first merchant entity;
processing the relevant customer transaction data to determine a set of customers that conducted purchase transactions at both the first merchant entity and a second merchant entity; and
utilizing the set of customers to determine a relational strength index that represents a strength of a transactional affinity between the first merchant entity and the second merchant entity.

2. The method of claim 1 wherein the stored customer transaction data includes an aggregation of purchase transactions conducted by a plurality of customers.

3. The method of claim 2 wherein the purchase transactions are conducted at points of sale respectively associated with a plurality of merchant entities that includes at least the first merchant entity and the second merchant entity.

4. The method of claim 3 comprising receiving purchase transaction data associated with the purchase transactions from the points of sale and storing the received purchase transaction data in a database as the stored customer transaction data.

5. The method of claim 1 comprising receiving a request for the relational strength index.

6. The method of claim 1 wherein the relational strength index is represented numerically.

7. The method of claim 6 wherein the relational strength index is one of a plurality of relational strength indices displayed as a relational ordered list of merchant entities.

8. The method of claim 1 wherein the relational strength index is represented graphically.

9. The method of claim 8 wherein the thickness of a line connecting representations of the first merchant entity and the second merchant entity on a visual display indicates the strength of the transactional affinity of the two merchant entities.

10. The method of claim 8 wherein the number of lines connecting representations of the first merchant entity and the second merchant entity on a visual display indicates the strength of the transactional affinity of the first merchant entity and the second merchant entity.

11. The method of claim 8 wherein the color of a line connecting representations of the first merchant entity and the second merchant entity on a visual display indicates the strength of the transactional affinity of the first merchant entity and the second merchant entity.

12. The method of claim 1 wherein the at least one data filter includes a time-based parameter.

13. The method of claim 1 wherein the at least one data filter includes a location-based parameter.

14. A system for determining a relational strength index between merchant entities, the system comprising:
a plurality of point of sale devices associated with a plurality of merchant entities, wherein each of the plurality of point of sale devices is configured to generate and send customer transaction data; and
a processing server configured to store customer transaction data received from the plurality of point of sale devices, apply at least one data filter to the stored customer transaction data to produce relevant customer transaction data associated with a first merchant entity, process the relevant customer transaction data to determine a set of customers that conducted purchase transactions at both the first merchant entity and a second merchant entity, and utilize the set of customers to determine a relational strength index that represents a strength of a transactional affinity between the first merchant entity and the second merchant entity, wherein the first merchant entity and the second merchant entity are included among the plurality of merchant entities.

15. The system of claim 14 wherein the stored customer transaction data includes an aggregation of purchase transactions conducted by a plurality of customers.

16. The system of claim 15 wherein the purchase transactions are conducted at the plurality of point of sale devices.

17. The system of claim 16 wherein the processing server is further configured to receive purchase transaction data associated with the purchase transactions from the plurality of point of sale devices and store the received purchase transaction data in a database as the stored customer transaction data.

18. The system of claim 14 wherein the processing server is further configured to receive a request for the relational strength index.

19. The system of claim 14 wherein the relational strength index is represented numerically.

20. The system of claim 19 wherein the relational strength index is one of a plurality of relational strength indices displayed as a relational ordered list of merchant entities.

21. The system of claim 14 wherein the relational strength index is represented graphically.

22. The system of claim 21 wherein the thickness of a line connecting representations of the first merchant entity and the second merchant entity on a visual display indicates the strength of the transactional affinity of the two merchant entities.

23. The system of claim 21 wherein the number of lines connecting representations of the first merchant entity and the second merchant entity on a visual display indicates the strength of the transactional affinity of the first merchant entity and the second merchant entity.

24. The system of claim 21 wherein the color of a line connecting representations of the first merchant entity and the second merchant entity on a visual display indicates the strength of the transactional affinity of the first merchant entity and the second merchant entity.

25. The system of claim 14 wherein the at least one data filter includes a time-based parameter.

26. The system of claim 14 wherein the at least one data filter includes a location-based parameter.

27. A non-transitory computer readable medium having stored thereon executable instructions for controlling a computer to perform steps comprising:
applying at least one data filter to stored customer transaction data to produce relevant customer transaction data associated with a first merchant entity;
processing the relevant customer transaction data to determine a set of customers that conducted purchase transactions at both the first merchant entity and a second merchant entity; and
utilizing the set of customers to determine a relational strength index that represents a strength of a transactional affinity between the first merchant entity and the second merchant entity.
